(19) United States
(12) Patent Application Publication
(10) Pub. No.: US 2012/0130794 A1
(43) Pub. Date: May 24, 2012

(54) Method and System for Managing Customer Relationships

(75) Inventor: William Alexander Strieder, Koeln (DE)

(73) Assignee: BNC VENTURES B.V., Maastricht (NL)

(21) Appl. No.: 13/361,703

(22) Filed: Jan. 30, 2012

Related U.S. Application Data
(63) Continuation of application No. PCT/AU2010/001212, filed on Sep. 17, 2010.

(30) Foreign Application Priority Data
Jun. 13, 2010 (AU) 2010902597

(51) Int. Cl. G06Q 30/02

(52) U.S. Cl. 705/14.27

(57) ABSTRACT

According to one embodiment, the method comprising the steps of creating, by a first user of the social networking site, at least one first profile associated with a business; creating, by a second user of the social networking site, at least one profile associated with a potential customer; generating, by the first or a third user of the social networking site, at least one machine readable token associated with the first profile; displaying the at least one machine readable token in an intended business context; capturing, by the second user, the at least one machine readable token with a mobile device; submitting, by the second user, information regarding the captured machine readable token to the social networking site; and automatically creating a link on the social networking site between the first profile and the second profile in response to the submitted information.

This application is a continuation of co-pending International Application No. PCT/AU2010/001212, filed Sep. 17, 2010, which designated the United States and was published in English as WO 2011/156832, and which claims priority to Australian Application No. 2010902597, filed Jun. 13, 2010, both of which applications are incorporated herein by reference.

### TECHNICAL FIELD

The present invention relates to different methods, systems and apparatuses for managing customer relationships. In particular, the invention relates to a method for managing customer relationships using a social networking site. The invention further relates to a method for operating an electronic customer relationship management system, an electronic customer relationship management system, a mobile application and a computer program product.

### BACKGROUND

The importance of maintaining good customer relationships has long been recognized by businesses worldwide. Due to the ever increasing local and global competition, maintaining good customer relationships becomes essential in achieving and maintaining business success. In order to position and reposition themselves on the market, business enterprises need to know how their customers behave and, also, in which way the behavior of the customer is changing over time. To answer those and similar questions, as much detail as available about business transactions between customers and businesses is required.

In order to gain such information, customers are often offered rewards as part of so-called loyalty systems. In particular customers are rewarded with certain discounts or free goods and services in exchange for identifying themselves whenever they purchase goods or services from a particular business.

While many systems integrating customer relationship management with reward programs have been devised, those systems and programs suffer from several drawbacks.

According to a first scheme, first employed for example by airlines and other large corporations, customers are issued with magnetic swipe cards or similar means of identification. Then, as a customer checks in, he or she presents his or her swipe-card and is rewarded a number of points or miles usually associated with a particular flight segment. In return, the airline or other business can gather statistical data about the behavior of its customers and motivate customer loyalty.

This and similar approaches require a considerable overhead in terms of providing the associated IT infrastructure and magnetic or electronic swipe cards for the individual customers as well as high operating costs for the operator of such customer relationship management systems. Due to the high cost, such systems are only employed by relatively large organizations, such as internationally operating airlines or large department stores. Furthermore, it is inconvenient for customers to carry the loyalty cards of multiple vendors in their wallet. Therefore, customers are increasingly reluctant to carry additional loyalty cards. As a consequence, both the customers and the businesses they frequent loose valuable rewards and information, respectively.

In contrast, methods for managing customer relationships for small and medium businesses (SMB) often suffer from a lack of flexibility and convenience. For example, so-called stamp cards provided by small scale businesses such as coffee shops often entitle frequent customers to a free item in return for a fixed number of purchases at the specific business. For example, a customer buying ten large coffees might be entitled to obtain an eleventh large coffee for free.

From the perspective of the owner of the business, such loyalty schemes provide only very limited information about their customers. In addition, it is inherently difficult to verify the correctness of the visits of a customer based on a simple stamp alone. Traditional stamp cards display a clear lack of measurability. From the perspective of the customer, the problem of carrying multiple stamp cards presents the same inconvenience as carrying multiple loyalty cards. In addition, these schemes are relatively inflexible and do not allow to accumulate rewards beyond the specific individual campaign.

Consequently, there exists a need to provide improved methods for managing customer relationships. In particular, methods applicable to small and medium enterprises should be provided, which allow a higher degree of flexibility with respect to managing customer relationships at a reasonable cost. In addition, the methods and systems described should be convenient to use for both businesses and customers alike.

### SUMMARY OF THE INVENTION

These and other problems are mitigated by the methods, systems and devices for managing customer relationships according to the present invention.

According to a first aspect of the present invention, a method for managing customer relationships on a social networking site is provided. The method comprises the steps of creating, by a first user of the social networking site, at least one first profile associated with a business and, by a second user of the social networking site, at least one profile associated with a potential customer. The method further comprises generating, by the first or a third user of the social networking site, at least one machine readable token associated with the first profile, and displaying the at least one machine readable token in an intended business context. It further comprises capturing, by the second user, the at least one displayed machine readable token with a mobile device, and submitting, by the second user, information regarding the captured machine readable token to the social networking site. It also comprises automatically creating a link on the social networking site between the first profile and the second profile in response to the submitted information.

The described method makes use of detailed information provided by profiles of a social networking site with respect to a business and a potential customer. By allowing to generate, display, capture and submit a machine readable token associated with the first profile or information contained in the machine readable token, a link between the customer and the business can be created in the social networking site. Such links between profiles allows both the potential customer and the business to get in contact with and learn more about each other, for example for the purpose of maintaining customer relationships. In addition, the use of machine readable tokens and mobile devices of the customer significantly reduces the initial investment for the business using such a method as compared to, for example, magnetic swipe cards.

According to an advantageous embodiment, the machine readable token is associated with at least one loyalty program of the business and is displayed at a point of sale or point of service. The potential customer is awarded loyalty points in accordance with a reward policy of the loyalty program in response to the submission of the information regarding the captured machine readable token. By associating the machine readable token with a loyalty program defined by or for the respective business associated with the first profile, an electronic loyalty scheme can be implemented which is flexible as well as convenient to manage and use for the business and the customer alike. In particular, loyalty schemes of multiple businesses can be hosted on the social networking site. Thus, the IT infrastructure in general and the software required in particular to implement such a loyalty scheme can be provided as a service to businesses, by a third party, such as the operator of the social networking site. Consequently, a given customer can participate in multiple loyalty schemes using a single registration of his profile in one social networking site.

According to a further embodiment of the method, the step of capturing the at least one machine readable token comprises obtaining a digital image of at least one barcode using a built-in camera of the mobile device and, optionally, identifying at least one identifier associated with the barcode using an application of the mobile device. Furthermore, the step of submitting information comprises establishing a connection between the mobile application and a submission interface and automatically submitting information regarding the captured machine readable token to the submission interface. For example, a so-called “app” can be used to capture, by the second user, the barcode presented at a point of sale. Capturing the barcode using a built-in camera of a mobile device such as a smart phone and an application running on that smart phone can be used to provide a particularly comfortable interface to the customer and also to display additional information on the mobile device. If, in an optional step, the identification of the barcode is also performed by the mobile application, the social networking site is relieved of the effort required in order to analyze the identifier associated with the barcode.

According to an alternative embodiment, the step of capturing the at least one machine readable token comprises obtaining a digital image of the at least one machine readable token using a built-in camera of the mobile device, and the step of submitting the obtained digital image to the social networking site and identifying the machine readable token associated with the first profile by the social networking site. This alternative implementation has the advantage that no special device or application is required on part of the customer. In particular, any modern camera phone capable of obtaining a digital image and sending it to a social networking site, so called feature phones, can be used in order to participate in the disclosed method for managing customer relationships. The transmission may be performed, for example, by means of multimedia messaging services (MMS) or e-mail.

According to a further advantageous embodiment, the step of submitting information further comprises submitting at least one identifier associated with the second user, such as a username of the customer on the social networking site, a universal device identifier (UID) or telephone number of the mobile device associated with the second user, to the social networking site. Submitting an identifier associated with the second user allows to automatically associate a second user with their associated second profile by means of information stored in the profile.

According to a further advantageous embodiment, the method further comprises the step of verifying the uniqueness of the submitted information based on auxiliary information associated with the captured machine readable token, such as a time stamp of a digital image. By verifying the uniqueness of submitted information based on auxiliary information, repeated submission of the same scan of a machine readable barcode can be prevented. For example, a customer can be prevented from resubmitting the same image taken a day earlier in order to increase his balance of loyalty points.

According to a second aspect of the invention, a method for operating an electronic customer relationship management system is disclosed. The method comprises the steps of storing at least one first profile associated with a business, storing a plurality of second profiles associated with a plurality of potential customers, and providing an electronic version of at least one machine readable token associated with the at least one first profile through the electronic customer relationship management system for printing by first user. It further comprises the steps of receiving information regarding at least one captured machine readable token from a mobile device associated with a second user, verifying that the received information is associated with the at least one machine readable token provided to the first user, and creating a link on a social networking site between the at least one first profile and one of the plurality of second profiles, which is associated with the second user from whom the information was received.

The steps described above allow to expand existing customer relationship management systems or to build new electronic customer relationship management systems in order to facilitate social networking for managing customer relationships between businesses and potential customers.

According to an advantageous embodiment, the social networking site comprises at least one privacy policy regarding access to information comprised in the first and second profiles, the at least one privacy policy comprising a first rule allowing first users of the social networking site to send collective messages to second users of the social networking site, whose associated second profiles are linked to the first profile, and for preventing to send collective messages to second users of the social networking site, whose associated profiles are not linked to the first profile. The privacy policy can be used in order to implement individual or legal data protection requirements. In particular, second customers, who have no business relationship to a particular business, can be protected from receiving collective messages, sent by a business which the second customer's profile is not linked with through the social networking site. In contrast, actual customers of a particular business, whose profiles are linked with at least one of the businesses profiles, can be contacted by the business in order to inform them about special offers and other relevant information.

According to a further advantageous embodiment, the privacy policy comprises a second rule for allowing first users of the social networking site to retrieve protected profile information of second users, whose associated second profiles are linked to the first profile, and for preventing to retrieve protected profile information of second users of the social networking site, whose profiles are not linked to the first profile. By means of the second rule, certain information considered protected by the second users, such as personal information like the date of birth or telephone number, can be hidden from a publically available part of the profile. At the same time, such information can be accessed by first users whose first profiles are linked with a given second user's profile, in order to implement an electronic loyalty scheme or similar program.

According to a third rule of the privacy policy, first users of the social networking site are allowed to retrieve aggregated information for all or a subset of second users, whose associated second profiles are linked to the first profile. Such provision and retrieval of aggregated information allows businesses to gather business and market intelligence and to gain customer insight. Consequently, businesses are able to adjust their business and marketing strategies based on the gathered information.

According to yet another embodiment, the at least one privacy policy comprises a fourth rule for allowing second users of the social networking site, whose associated second profiles are linked to the first profile, to access restricted information provided by the first user of the social networking site and for denying second users of the social networking site, whose associated second profiles are not linked to a first profile, to access the restricted information provided by the first user. Such a rule can be provided, for example, to provide additional product or service information to customers who are registered with a customer relationship program of a particular business.

According to a third aspect, an electronic customer relationship management system is provided. The system comprises a social networking site comprising a plurality of first profiles associated with a plurality of businesses and a plurality of second profiles associated with a plurality of potential customers. The system further comprises a token generator that allows first users to create machine readable tokens on demand which are associated with a first user's profile. Furthermore, the system comprises a token submission interface for receiving information regarding at least one captured machine readable token from mobile devices. The system further comprises a link generator for creating a link on the social networking site between the first profile associated with a previously created machine readable token associated with the first profile and the second profile associated with the potential customer from whom the information regarding the at least one captured machine readable token was received.

Such an electronic customer relationship management system allows a fully integrated, convenient and modern approach to customer relationship management. In particular, the generation of tokens, needed to implement the customer relationship management system in general or loyalty program in particular, can be integrated with a social networking site for providing direct links between businesses and their customers. Thus, tokens can be generated automatically and on demand, i.e. the machine readable tokens can be generated by a first user whenever they are needed.

According to a further embodiment, the system comprises a user management subsystem for providing privileges to users of the electronic customer relationship management system, wherein a first user associated with at least one of the plurality of first profiles is privileged to grant administrative rights to third users of the electronic management system, for example to allow a third user to create machine readable tokens associated with at least one of the first user's profiles. By means of a user management subsystem, additional users of the electronic customer relationship management system can be empowered to manage customer relationships. For example, branch managers or specialized marketing professionals can be privileged to access required parts of the electronic customer relationship management system.

Further aspects of the present invention relate to an application for a mobile device and a computer program product for managing customer relationships on a social networking site.

In other words, various embodiments of the invention relates to all online and mobile services that utilize custom-programmable, machine-readable tokens, such as two-dimensional barcodes, that link to online content, such as discounts and rewards, in order to facilitate marketing and customer relationship management activities between businesses and their customers.

Further advantageous features and embodiment of the present invention are disclosed in the appended claims as well as in the following description of detailed embodiments.

### BRIEF DESCRIPTION OF THE DRAWINGS

The invention will be described with reference to various exemplary embodiments shown in the Figures attached to this specification, wherein identical reference numbers are used for like elements of different embodiments of the present invention. For a more complete understanding of the present invention, and the advantages thereof, reference is now made to the following descriptions taken in conjunction with the accompanying drawing, in which:

FIG. 1 shows an electronic customer relationship management system comprising a social networking site;

FIG. 2A shows a first example of presenting at least one machine readable token in a business context;

FIG. 2B shows a second example of displaying at least one machine readable token in a business context;

FIG. 3 shows a schematic representation of a method for managing customer relationships;

FIG. 4A shows a first mobile device for submitting information regarding to a captured machine readable token;

FIG. 4B shows a second mobile device for submitting a digital image of a captured machine readable token;

FIG. 5 shows interfaces and modules for accessing an electronic customer relationship management system;

FIG. 6 shows a detailed flow chart of a method for managing customer relationships; and

FIGS. 7A to 7C show different screens of an exemplary social networking site for managing customer relationships.

### DETAILED DESCRIPTION OF ILLUSTRATIVE EMBODIMENTS

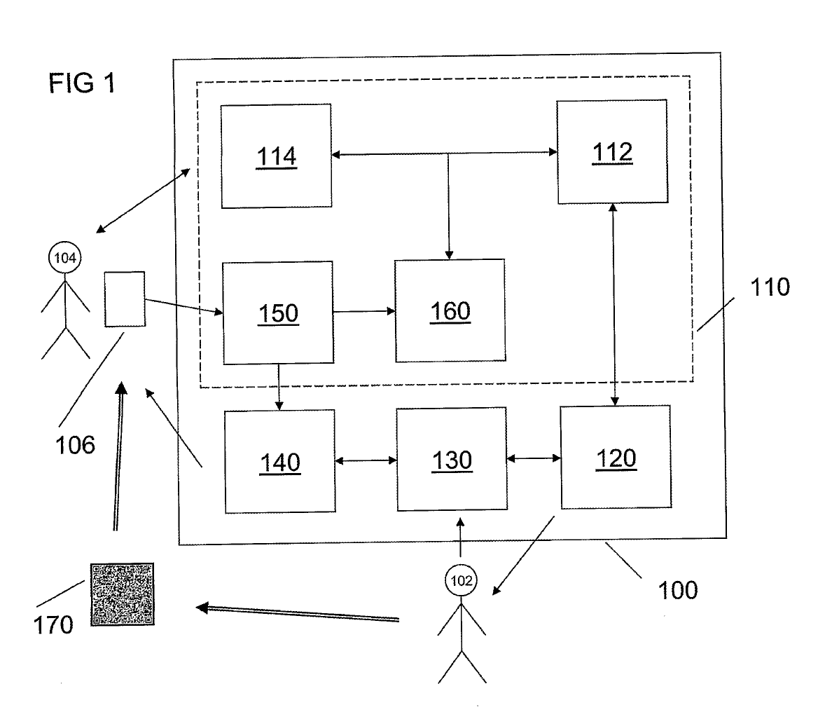

With reference now to FIG. 1, there is shown an exemplary embodiment of an electronic customer relationship management (CRM) system 100 in accordance with the present invention.

The CRM system 100 is accessed by both business users 102 and individual users 104 alike. Individual users 104 may be customers of businesses owned or managed by the business users 102. Preferably, each individual user 104 accesses the CRM system 100 by means of a mobile device 106. Suitable mobile device 106 comprises, among others, so-called smart phones, feature phones and personal digital assistants (PDA).

The CRM system 100 comprises a social networking site 110. The social networking site 110 may be fully incorporated into the CRM system 100, as shown in FIG. 1, or just be incorporated or accessed by an interface module to an existing social networking site such as Facebook, MySpace or the like. Inversely, the CRM system 100 may also be implemented as a software module within an existing social networking site.

In the embodiment shown in FIG. 1, the CRM system 100 also comprises additional modules. The additional modules may either be part of the social networking site 110 or independent of it. In particular, according to the embodiment shown in FIG. 1, the CRM system 100 further comprises a barcode generator 120, a campaign manager 130, a reward system 140, a token submission interface 150 and a link generator 160.

The social networking site 110 comprises a plurality of profiles 112 and 114, which are associated with businesses of the business user 102 and individual user 104, respectively. In particular, one or more business profiles 112 can be associated with a business user 102 directly, indirectly via a marketing campaign managed by the business user 102 using the campaign manager 130. In contrast, only one individual personal profile 114 is associated with each registered individual user 104 of the social networking site 110.

In the following, the operation of the CRM system 100 will be described for use in a so-called loyalty system. However, as explained later, other uses of the CRM system 100 are also envisioned.

As a first step, a business user 102, for example a shop keeper of a small business or a marketing manager of a medium or large-sized business, registers with the CRM system 100. For example, registration might be achieved by means of a registration interface of the social networking site 110 or a separate web service provided by the CRM system 100. Of course, other means of registration are also possible. For example, a registration by telephone or mail is also possible. Typically, business users will be charged for the use of the CRM system 100 or social networking site 110 by their respective operators. Cost may be incurred as a one-off fee for registration, monthly subscription fees, or transaction fees for generation and/or submission of barcodes or a combination of both. Also, additional functionally of the CRM system 100, such as the transmission of electronic messages to customers or analysis of statistical data, might only be provided at additional costs. Therefore, the registration of a new business user 102 usually includes the provision of some financial data, such as a credit card or account number. However, these details will typically not be included in the company profile 114, but may be kept separate for accounting purposes.

Once the business user 102 has access to the CRM system 100, he or she can define at least one business profile 112 within the social networking site 110. The business profile 112 preferably comprises the name of the business, contact information such as contact e-mail address, a telephone number, pictures related to the place of business or the products on sale, service information such as opening times and information about products or special offers, and, optionally, online links to further resources such as an website of the business, a corresponding Twitter feed, and further profile pages either on the same social networking site 110 or other social networking sites. The business profile 112 may be associated with the business user 102 directly or indirectly by means of one or more campaigns organized by the optional campaign manager 130. In particular, small businesses will typically only have one business profile 112 associated with their place of business, whereas larger businesses might have different profiles associated with either different advertising campaigns or different locations or branches of the business.

Next, the business user 102 may generate one or more barcodes 170, for example so-called two-dimensional QR codes according to ISO/IEC18004 or other machine readable tokens by means of the barcode generator 120. The barcode 170 generated by the barcode generator 120 is associated with either the business profile 112 directly or indirectly via a campaign managed by the campaign manager 130. For example, for a relatively small business, the generated barcode 170 might be directly associated with a business profile 112 of their business. Larger businesses, however, may associate different barcodes 170 with different advertising campaigns or branches of their businesses. For this purpose, the barcode 170 comprises a unique identifier, such as a database key value, a uniform resource identifier (URI) or a uniform resource locator (URL).

The barcode 170 generated by the CRM system 100 can be downloaded by the business user 102 and included in his or her marketing material. For example, the barcode generated by a web service which forms a part of the CRM system 100 can be printed off by the business user 102 and placed close to a point of sale (POS). For example, an information sheet containing relevant information to a loyalty scheme can be printed on a piece of paper including the barcode 170 generated by the barcode generator 120 and placed near the till of the business. Preferably, barcodes 170 that contain reward point information will not be displayed publicly, but rather only presented to customers who have actually completed a purchase. In order to attract attention to the scheme, a second sheet or a sticker can be displayed publicly in order to inform patrons of a business's participation.

The barcode 170 can then be scanned by customers of the issuing business, using their mobile devices 106 whenever they make a purchase. However, before any rewards can be awarded to any individual user 104, he or she will also need to create an individual profile 114 on the social networking site 110. Preferably, the individual profile 114 comprises as much information about the individual user 104 as desirable for marketing purposes of the business users 110. In particular, the individual profile 114 should comprise at least the real name of the customer, and at least one means of contacting him or her electronically (e.g. e-mail address or mobile phone number). In addition, in order to obtain at least some demographic information about the individual user 104, the individual profile 114 should also comprise additional information regarding his or her age or date of birth, sex, and/or a postal address. Furthermore, information regarding his or her interests, or links to further information on a private homepage or the same or other social networking sites might also be included in the individual profile 114. Of course, other information such as profile pictures of the individual user 104, links to other profiles or applications of the social networking site 110 and further content may also be included. Registration of the individual profiles 114 for individual users 104 is preferably free of charge, that is, no financial details such as credit card numbers or the like need to be supplied. Instead of creating a new profile, individual users 104 may also provide a link to an existing profile on another social networking site.

When the individual user 104 scans a barcode 170 for the first time, he or she will automatically be entered into the particular loyalty scheme associated with the submitted barcode 170 and business profile 112. For this purpose, the individual user 104 typically needs to agree to the conditions of service of a loyalty scheme or the like. Such conditions of service can either be provided globally for the CRM system 100, in which case the individual user 104 has to agree to these terms and conditions upon registration to the social networking site 110 or upon the first use of the CRM system 100 within the social networking site 110. However, in order to suit the conditions to the individual businesses, the terms of a given scheme might also be provided by the business users 102 during the creation of either campaigns using the campaign manager 130 or barcodes 170 using the barcode generator 120. In this case, the mobile device 106 may display the particular terms and conditions associated with the barcode 170 upon a given user's first scanning of that barcode 170 or submitting it to the token submission interface 150.

Submission of the scanned barcode 170 by the mobile device 106 can take different ways according to the category of the mobile device 106 used by the individual user 104. In case the individual user 104 only has a digital camera, especially a feature phone with limited capabilities, he or she may use the mobile device 106 to obtain a digital image of the barcode 170 at the place of business. Then, either immediately or later on, for example at home when connecting the mobile device 106 to the Internet, the digital image of the barcode 170 can be submitted to the token submission interface 150. For example, the digital image might be submitted by means of a web service or interface of the social networking site 110. In addition, the user might have to supply information that allow an identification of the individual user 104. For example, a login into the social networking site 110 using a user name and a password, or an automatic identifier such as the e-mail address of the individual user 104 or the telephone number of the mobile device 106 might be used to identify the individual user 104.

Preferably, however, the mobile device 106 is a so-called smart phone with enhanced capabilities. In particular, the mobile device 106 is capable of executing so-called “apps”, i.e. mobile applications running on the smart phone. The app of the mobile device 106 can directly communicate with the token submission interface 150, for example, by means of exchanging XML or similar computer readable messages. Consequently, the individual user 104 only needs to register his phone once with the token submission interface 150 or provide information such as the telephone number of his smart phone 106 as part of his individual profile 114 to the social networking site 110. Then, whenever a new barcode 170 is scanned using the app of the mobile device 106, an automatic connection between the mobile device 106 and the token submission interface 150 can be established. In addition, the app might also be used to highlight important legal information to the individual user 104. For example, if the business user 102 changes the terms of contract regarding a loyalty scheme, these amended conditions might be displayed on the mobile device 106 upon submission of the next barcode 170.

In one embodiment, the token submission interface 150 comprises a token verifier. The token verifier can verify both the correctness of a scanned barcode 170 and also the uniqueness of the scan. For example, the token submission interface 150 can, in a first stage, check if the image provided by the mobile device 106 comprises a barcode 170 at all. If such a barcode 170 is detected in the digital image, it can further verify that the barcode 170 was actually created by the barcode generator 120.

If both these preconditions have been met, i.e. if information can be retrieved from the barcode 170, which is associated with a particular business profile 112 or campaign of the CRM system 100, the token submission interface 150 can, in the next step, verify if the particular individual user 104, who is submitting the barcode 170 has previously submitted the same barcode 170. If this is not the case, the individual user 104 might be requested to confirm the terms and conditions associated with that particular barcode 170 as described above.

If the individual user 104 has already submitted a barcode 170 associated with the same business profile 112 or campaign, the token submission interface 150 might, in a further step, verify the uniqueness of the scanned image provided by the individual user 104. For example, time stamp information usually incorporated into digital images might be compared with data stored in connection with an earlier submission to the token submission interface 150. For example, as a general rule, the token submission interface 150 might only accept one scan of a particular barcode 170 from a particular user 104 within a given time period. In an advantageous embodiment, the frequency and conditions required to identify a scan of a barcode 170 to be unique might be further specified by the business user 102. For example, while an owner of a coffee shop might allow relatively frequent scans of a barcode 170, associated for example with the purchase of a cup of coffee, a car rental company might only allow to submit one barcode per working day.

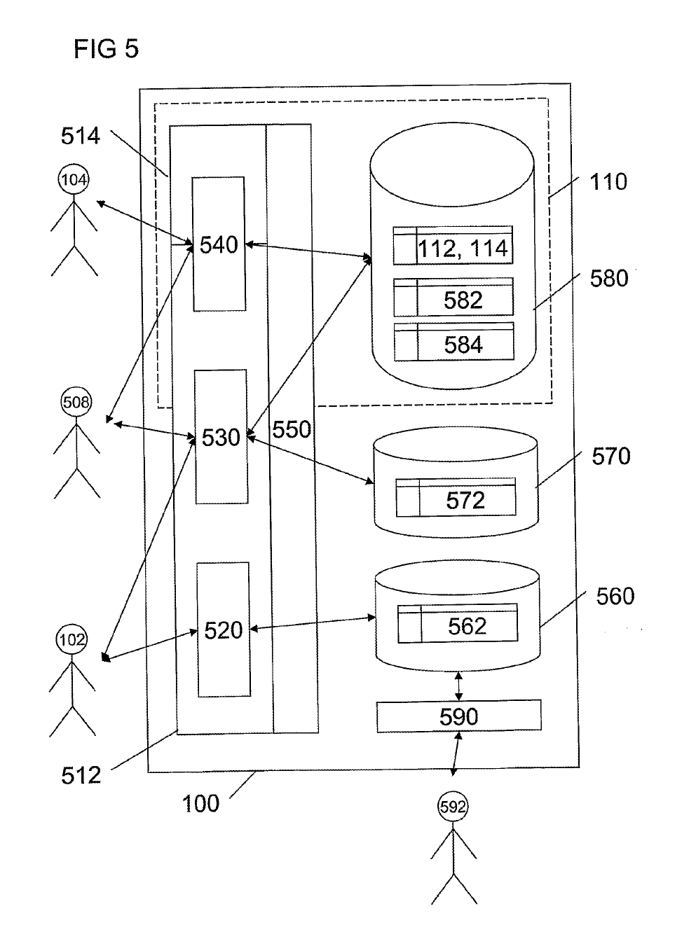

If the token submission interface 150 confirms the correctness of the barcode 170 submitted by the individual user 104, in a next step, a link is created between the individual customer profile 114 and the business profile 112 by means of the link generator 160. As a consequence, both the owner of the business profile 112 as well as the individual user 104 who is associated with the individual profile 114 can obtain further information about the other party. For example, the individual user 104 might access non-public parts of the business profile 112 related to additional services reserved for existing customers. In return, the business user 102 might gain insights into an existing customer base by virtue of evaluating the information on customer profiles 114. The business user 102 can evaluate such information either per individual customer profile 114 or in an aggregate mode of all customer profiles that are linked with at least one of the business profiles 112, associated with that particular business user 102. For reasons of data protection and security, some or all of the information contained in the profiles 112 and 114 might be restricted according to a particular privacy policy. In addition, individual users 104 may opt-out of a particular loyalty scheme by deleting the link to the respective business profile 112 from their individual profile 114. However, in this case they will lose all their associated reward points and other benefits. Details regarding the privacy policy of the social networking site 110 will be detailed later with respect to FIG. 5.

In order to make it more attractive for the individual user 104 to provide access to her or his individual profile 114, the individual user 104 might be offered virtual or real rewards as part of an advertising campaign or loyalty scheme. For example, according to a loyalty scheme defined by the business user 102 by means of the campaign manager 130, one free cup of coffee might be offered to a customer in return for ten visits to a particular coffee shop. For this purpose, the token submission interface 150 also provides information about successfully submitted scans to the reward system 140. Once the reward system 140 registers that the conditions of a particular advertising campaign or loyalty scheme have been met, it informs the business user 102 and/or the individual user 104 that the individual user 104 is entitled to his particular reward. For example, in response to the tenth successive scan of a barcode at the coffee shop, a message might be provided to the mobile device 106 which can be shown to the shop owner of the coffee shop in order to obtain a free cup of coffee.

In a further embodiment, different business users 102 of the CRM system 100 may also co-ordinate the campaigns in order to make the reward schemes more attractive. For example, a coffee shop and a nearby sushi restaurant might cooperate to share and enlarge their respective customer bases. For this purpose, they may link their respective profiles and campaigns and agree on an exchange rate for their respective reward points. For example, they might add rules to their reward schemes, so that customers might be able to choose to receive a free sushi dish as reward for a certain number of submitted scans from the coffee shop or vice versa. For this purpose, individual businesses might define exchange rates between their reward schemes. For example, a coffee shop and a sushi restaurant may agree to allow mutual customers to use the reward points of both businesses interchangeably. However, as both businesses may require ten submitted scans in return for respectively different rewards. Consequently, an exchange rate between the respective campaigns may be desired by these businesses. For example, the sushi restaurant could exchange one of the coffee shop's reward points for only 0.5 reward points, while the coffee shop may agree to exchange one reward point from the sushi restaurant for two reward points within their own campaign.

In addition, or alternatively, there might also be means for individual users 104 to trade their reward points within the social networking site 110. In particular, a regular customer, i.e. a first individual user 104 of a given business may decide to pass reward points of that business on to another individual user 104. The rules applicable to such transactions may be provided by the operator of the CRM system 100 or by the individual business users 104 participating in a particular reward scheme. As a sole condition, all participants must be registered users of the social networking site 110 and have their respective profiles 114 linked to the business profile 112 to which any given reward scheme is associated. This and other features highlight both the flexibility and powerful functionality obtained by combining the incentives of conventional reward schemes with the collaborative powers of a social networking site 110 for the purpose of customer relationship management.

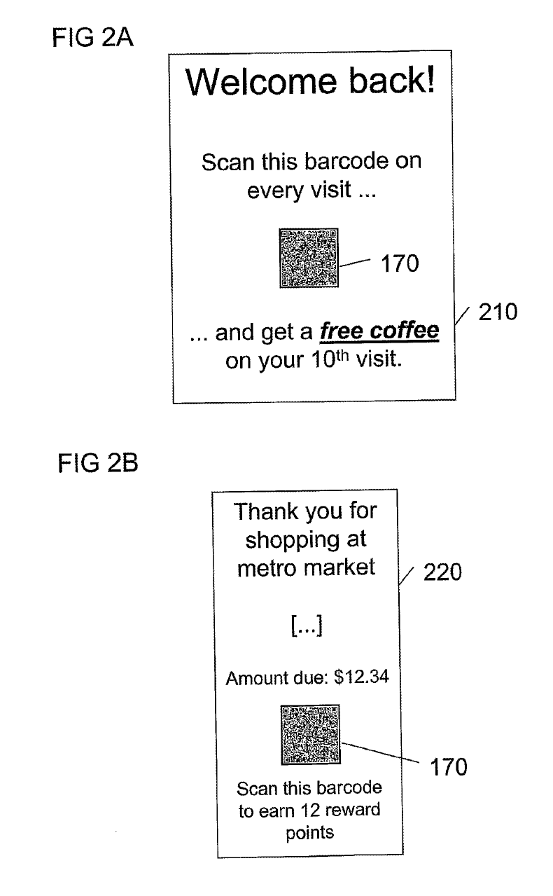

FIG. 2A and FIG. 2B show different, exemplary, ways of presenting the barcodes 170 in a business context. For example, as detailed above, the barcode 170 might simply be printed on a piece of paper, preferably together with the conditions for obtaining a particular reward. Preferably, such information will be embedded in a particular advertising campaign and can be prepared using the corporate design of the particular business. A poster 210 comprising such information is shown in FIG. 2A.

Alternatively, in case the business makes use of an advanced electronic till system, which is capable of printing barcodes, the barcode 170 might also be printed directly on a customer receipt 220 as shown in FIG. 2B. For example, a supermarket chain might provide barcodes 170 which are individualized according to the total sum of the purchases or a specific campaign of the supermarket chain on their checkout receipts.

Furthermore, the generated barcode 170 might also be attached to an object associated with a business activity. For example, a barcode 170 might be presented on a stall at a trade show in order to allow interested parties to link their profiles 114 to the profile 112 of the issuing user 102. Also, the barcode could be attached to a property for sale and linked to the profile 112 of a real-estate agent. Similarly, such a barcode 170 might even be incorporated in a presentation, for example into slides shown during a presentation to a large audience.

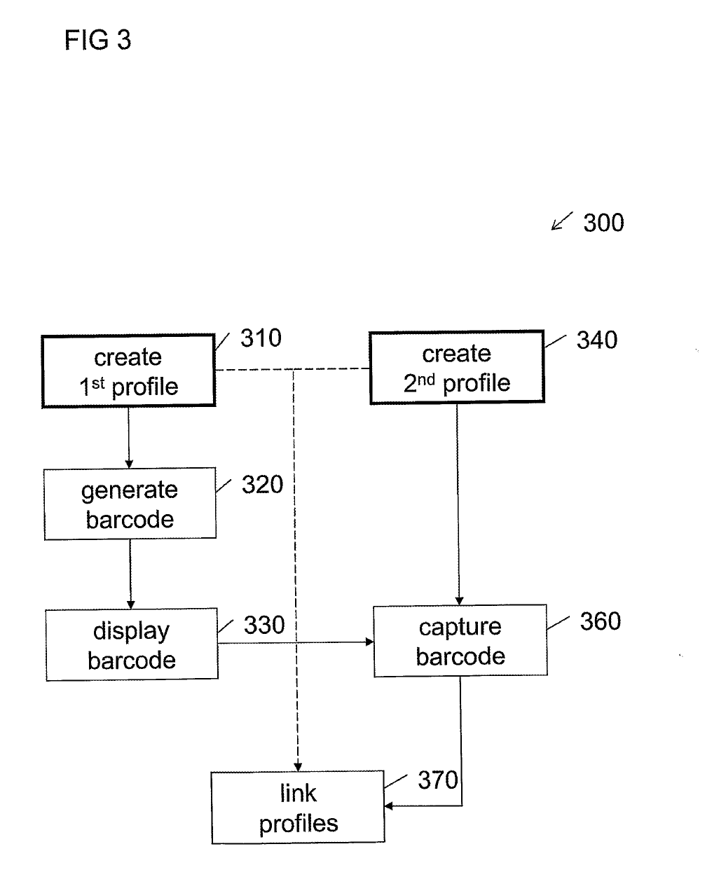

FIG. 3 shows the steps performed to link a business profile 112 with an individual profile 114 at a glance.

In a first step 310, the business profile 114 is created by a first person. In a second step 320, a machine readable token, such as a two-dimensional barcode 170 is generated. In a third step, the generated barcode 170 is displayed in a business context in step 330. In a step 340, a second person, such as customer, creates an individual profile 114. Then, in a subsequent step 360, the barcode 170 presented in step 330 can be captured by the person associated with the individual profile 114. In consequence, in a step 370, the profiles 112 and 114 are linked within a social networking site 110.

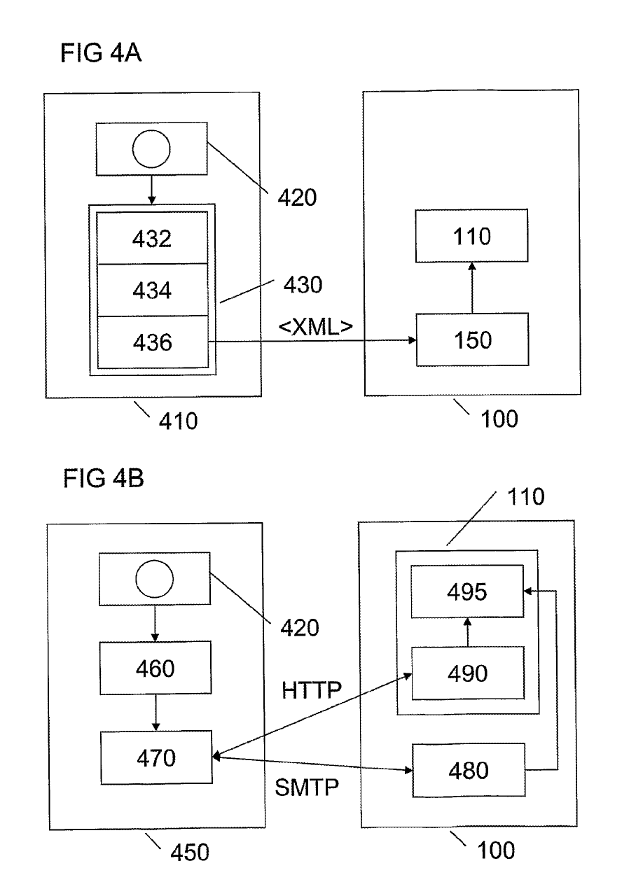

FIG. 4A and FIG. 4B show different means of capturing the machine readable token by means of a mobile device 106.

In particular, according to the scenario depicted in FIG. 4A, a smart phone 410 having an in-built camera 420 is used to capture a two-dimensional barcode 170. A so-called app is installed on the smart phone 410. The app 430 controls the camera 420. In particular, once activated the app 430 guides the user to direct the camera 420 such that the barcode is in its field of view. Then, when the barcode 170 is clearly visible, for example on a preview window of the app 430, a digital picture of the barcode 170 is obtained by a module 432.

In a first embodiment, the digital image itself is then forwarded to the submission interface 150 for analysis and verification. However, in another embodiment, a verification module 434 of the app 430 verifies that the barcode obtained by the image obtaining module 432 can be read. In particular, the verification module 434 can verify that the barcode is of a type as generated by the barcode generator 120 and contains an identifier, such as a uniform resource locator (URL) or uniform resource identifier (URI), associated with a campaign of the campaign manager 130 or a business profile 112. A submission module 436 then extracts the identifier obtained by the verification module 434 and encapsulates it in a suitable format for transmission to the token submission interface 150. For example, a URI or URL obtained by the verification module 434 can be embedded in an XML message in order to contact a web service provided as part of the social networking site 110. The generated XML message might further comprise additional information, such as a user ID of a individual user 104 for the social networking site 110. Alternatively, or in addition, the XML message might also include other details such as the e-mail address or the telephone number of the individual user 104 and details related to the scan used for its verification, such as the time the image was taken or a present geographic position identified by means of a location based service of the smart phone 410.

According to FIG. 4B, a feature phone 450 is used to capture the barcode 170. As detailed with respect to FIG. 4A, the feature phone 450 also includes a built-in camera 420. However, the feature phone 450 is not necessarily equipped to execute applications that can directly communicate with a web service, the feature phone 450 may also be a smart phone that is not compatible with any application offered by the operator of the social networking site. Instead, the feature phone 450 comprises a conventional digital image capturing system 460, such as software provided for controlling the built-in camera 420. The image captured by the image capturing system 460 can then be transmitted by means of a conventional communication system 470, such as an e-mail or web client, to a corresponding e-mail server 480 or web interface 490 of the token submission interface 150. In this case, additional information contained in the specific medium used for transmission can be used to identify the individual user 104. For example, if the digital image is received by the e-mail interface 480, the e-mail address of the sender will be used to identify the individual user 104. Alternatively, if the digital image is provided by means of the web interface 490, login credentials of the user for the web interface 490 might be used. Preferably, these may coincide with the login credentials, used for the social networking site 110, in particular when the web interface 490 forms a part of the social networking site. In both cases, verification of the submitted digital image of the barcode 170 is provided by a verification module 495 of the CRM system 100.

FIG. 5 shows the access control to the CRM system 100. In particular, it shows the different means and resources different users of the CRM system 100 are allowed to access according to one described embodiment.

Individual users access the CRM system 100 by means of a restricted interface 514, which forms part of the social networking site 110. Business users 102 may also access the CRM system 100 by means of the restricted interface 514 or by means of an extended user interface 512. The extended interface 512 might be a separate web service or part of an IT system of the business. For example, existing legacy systems might be integrated to access the CRM system 100 by means of a software interface. Of course, the extended user interface 512 may also be part of the social networking site 110.

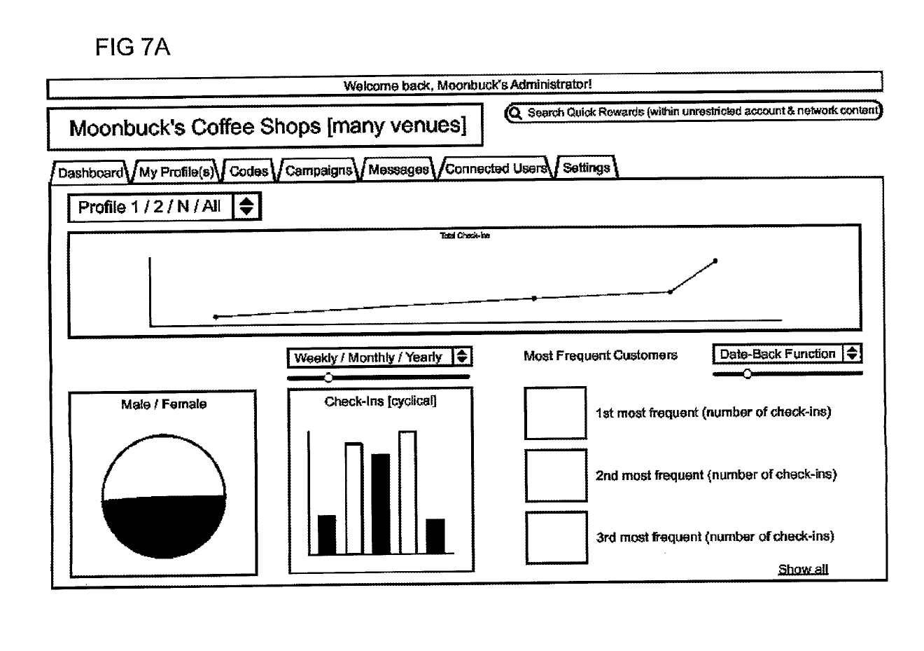

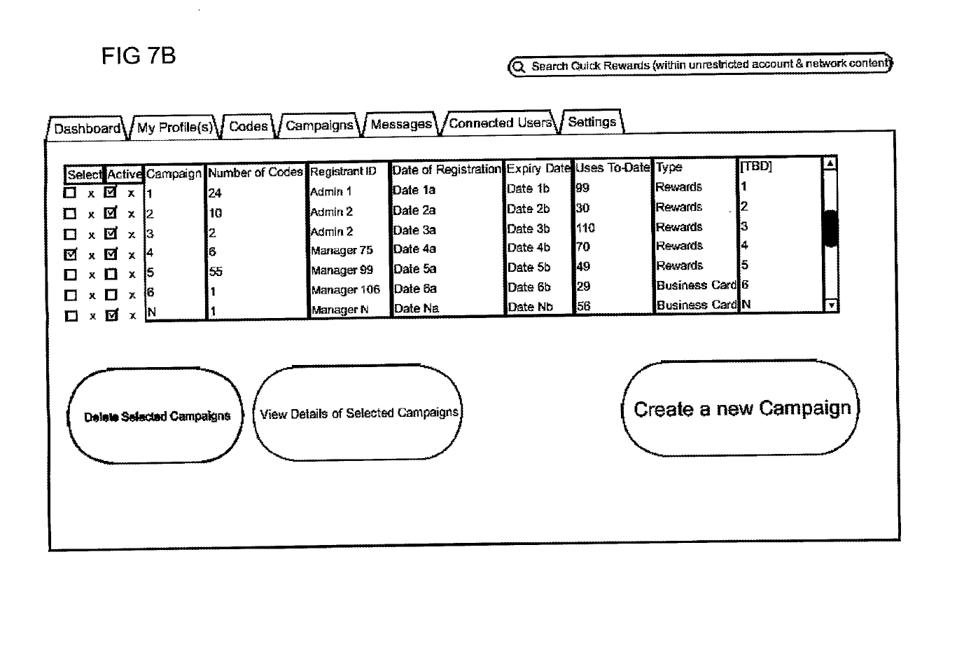

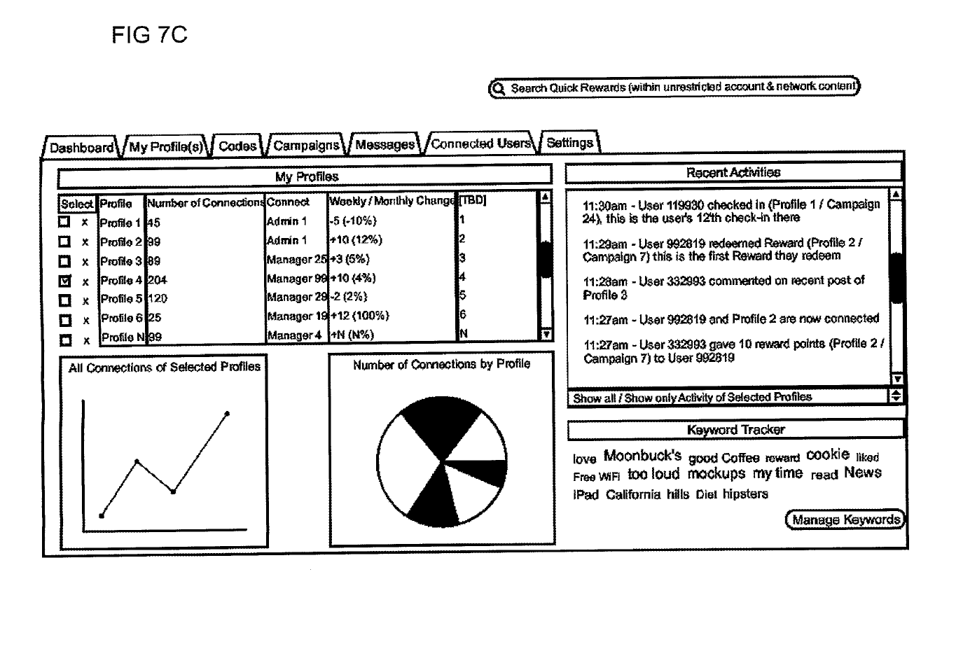

In the embodiment shown in FIG. 5, the extended interface 512 controls a user management subsystem 520. The user management subsystem 520 may be used to grant access rights to other users of the CRM system 100. For example, business users 102 might be privileged to grant access rights to a company profile 114 to individual managers or other employees of the business. In FIG. 5, a management user 508 is shown. In the example described, the management user 508 cannot provide further rights to other users of the CRM system 100. That is, the user management subsystem 520 employs a hierarchical access rights management scheme. However, the management user 508 can make use of other features provided by the CRM system 100, such as barcode generation, campaign definition and messaging by means of the extended user interface 512. An example of a page of a social networking site 110 used for managing management users 508 and profiles 112 associated with a particular business is shown in FIG. 7C.

The extended interface 512 also provides access to an analysis subsystem 530. By means of the analysis subsystem 530, the business user 102 or the management user 508 can analyze the activities related to their associated profiles 112. For example, they can analyze how many users have accessed a profile 112 or submitted a barcode 170 linked to the profile 112. Furthermore, they might be provided with aggregated data about the information provided in the individual profiles 114 of all individual users 104 whose associated profile 114 is linked to the company profile 112. In this way demographic information such as age or gender distribution of a given customer base can be obtained.

The restricted interface 514 also provides a messaging subsystem 540. All users 102, 104 and 508 can access the messaging subsystem 540. However, while the individual users 104 may use the messaging subsystem 540 only to send individual messages to other users of the social networking site 110, the business user 102, or an authorized management user 508, can send collective messages to large subgroups of users of the social networking site 110. In particular, these users may send marketing messages to all individual users 104, whose associated profile 114 is linked to a business profile 112 of their business.

All access rights are controlled by a privacy policy management subsystem 550. In a preferred embodiment, all users 102, 104 and 508 have access to the privacy policy management subsystem 550. For example, individual users 104 can define which of the information provided in the individual profiles 114 is accessible to all users of the social networking site 110 or only to users whose profile is linked to their profile 114. In addition, some information might be declared public and is available even to people who are not registered users of the social networking site 110. For example, some limited information about a business associated with a business profile 112 might be visible by means of a web interface of the social networking site 110 to all Internet users.

The privacy policy management subsystem 550 accesses a first data base 560 comprising a set of privacy rules. The privacy rules 562 basically define the individual access rights to the resources of the social networking site 110 and/or the CRM system 100. In addition, the privacy rules 562 might provide more generic rules which apply to groups of users. For example, a business user 102 might define in the conditions of a reward scheme, that an individual user 104 has to provide at least the date of birth in order to participate in a particular reward scheme, but that management users 508 are only allowed to access the aggregated age of all individual users 104. An example of a so called “dashboard” page of the social networking site 110 comprising aggregated data of connected individual users is shown in FIG. 7A.

The CRM system 100 further comprises a second data base 570 which comprises campaign information 572. The campaign information 572 comprises information on all barcodes 170 issued by the barcode generator 120. For example, the campaign information 572 might be used to link barcodes generated by the barcode generator 120 with profiles 112 of a particular business. In addition, the campaign information 572 might comprise rules related to a particular reward scheme. For example, the campaign information 572 might comprise information about the validity of barcodes 170, the number of scans of a particular barcode 170 required to obtain a particular reward and other information related to marketing campaigns of the business. An example of a page of the social networking site 110 for creating and managing campaign of a business is shown in FIG. 7B.

The CRM system 100 further comprises a third data base 580 which comprises data displayed via the social networking site. For example, the third data base 580 might comprise the company profiles 112 and the individual profiles 114. Furthermore, the data base 580 might also provide static content 582 such as pages created within the social networking site 110 that represent a particular business or service. In addition, the third data base 580 might also comprise messages 584 which have been sent by users of the social networking site 110. The third database 580 might also comprise messages 584, which are automatically sent in case a new user 104 accesses the social networking site 110 for a first time or is linked to a profile 112 for the first time.

At last, the CRM system 100 comprises an administration interface 590. The administration interface 590 can only be accessed by administrators 592 of the CRM system 100. By means of the administration interface 590, the administrator 592 might perform general system maintenance. For example, the administrator 592 might provide globally valid privacy rules 562 which define the rules of the different groups of users 102, 104, and 508. In addition, the administrator 592 might perform general maintenance work such as backing up data and the like.

The administrator 592 might further access extended statistic about the use of the CRM system 100. For example, the administrator 592 might monitor the activities related to one or more business users 102. Based on that information, the administrator 592 might also analyze the amount of fees to be paid by individual business users 102 of the CRM system 100.

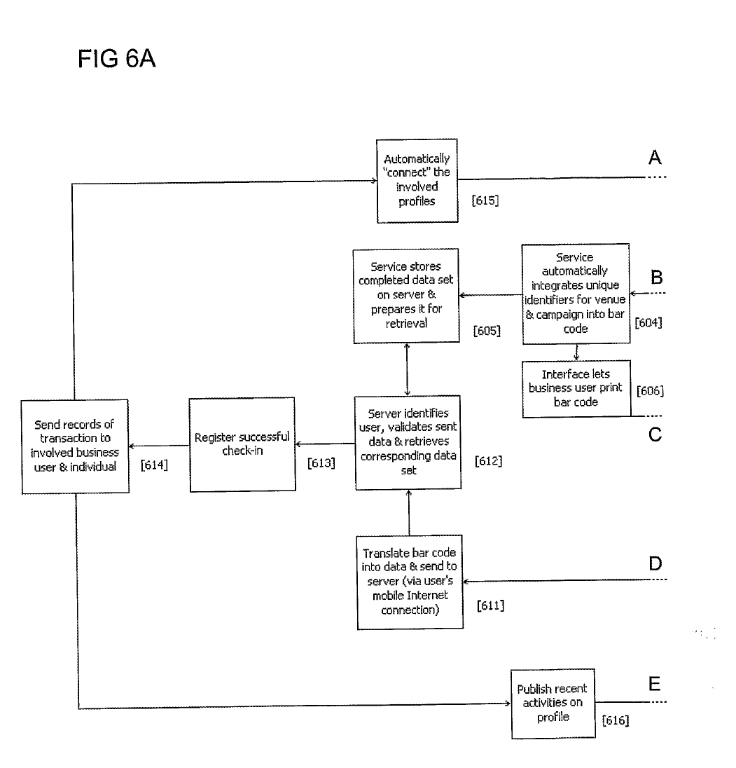

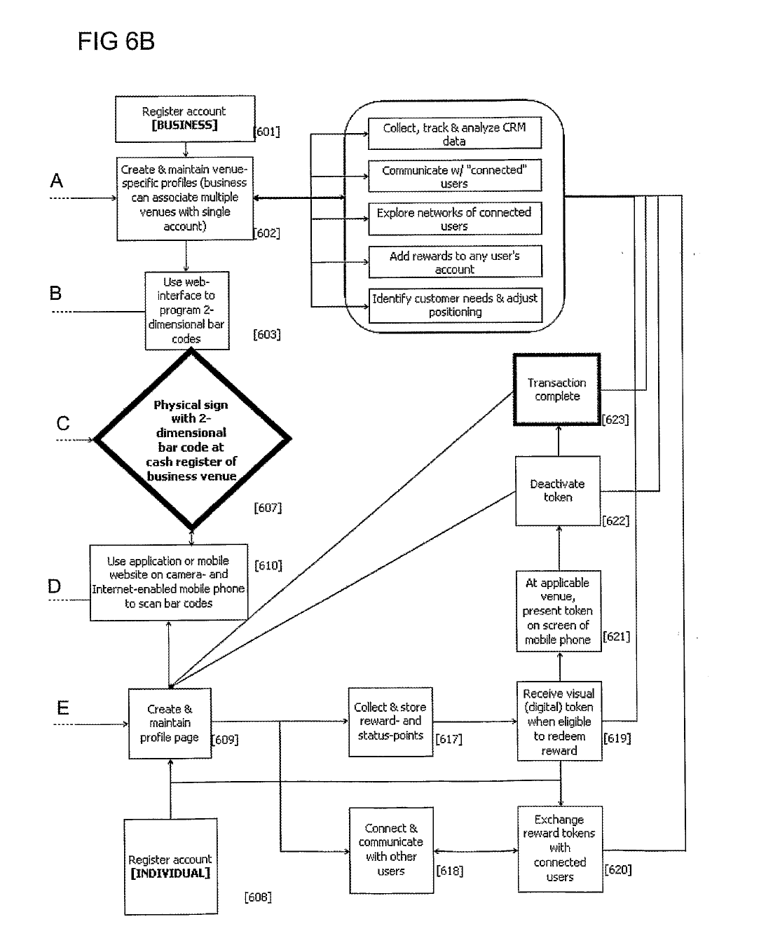

FIG. 6 shows a detailed flow chart of the operation of an exemplary CRM system 100. Its individual method steps 601 to 623 are detailed in the table below:

| | |
|---|---|
| [601] | Business vendor registers an account (payment facilitation and |
| | business contact) |
| [602] | Business vendor creates and curates profile pages for each |
| | venue (venue contact details, operating hours, menu, etc.) |
| | Profile pages can be managed centrally or individually (by |
| | venue managers, for example) |
| | Unlimited number of venue profiles can be associated with each |
| | account |
| | Business users track customer visits and analyze customer data |
| | (geographic/demographic/psychographic) in respect to a selected |
| | venue or in respect to all venues registered with a given account |
| | Business users can identify and communicate with consumer |
| | users who participate in a venue's reward program |
| | Business users can explore the networks of consumer users they |
| | are connected with - enabling them to identify prospects |
| | Business users can add reward points to the applicable accounts |
| | of consumer users - creating an unwarranted and personalized |
| | reward (birthdays of consumer, for example) |
| | Business users can clarify the needs and desires of consumer |
| | users by employing a number of direct and indirect metrics that the |
| | service provides - enabling business users to adjust their venue's |
| | positioning and thus capture more value from their customers |
| | For consumer users, the profile pages of venues provide |
| | information about a given venue and provide an access point of |
| | communication with the business |
| | Monthly subscription fees apply per registered venue |
| [603] | Venue manager uses web-interface to generate 2-dimensional |
| | barcodes that are associated with a given venue |
| | Venue manager provides information as to the desired |
| | specifications of the reward program they wish to employ |
| | Example 1: Consumer has to register 10 ‘check-ins’ to receive 1 |
| | free medium sized cup of coffee for free |
| | Example 2: Whoever registers a ‘check-in’ receives an instant |
| | 5% discount |
| | Example 3: Whoever registers the most ‘check-ins’ between |
| | January 1, and Jan. 8, 2011, receives a $10 voucher |
| [604] | The custom information, along with information about the |
| | applicable venue is stored as a unique data set on central server |
| | Each data set (campaign) has a unique identifier |
| | Unique identifier is the essential information, translated into the |
| | final barcode |
| [605] | Uniquely identifiable data-sets are stored on central server and |
| | prepared for retrieval |
| [606] | Completed barcode can be printed, using any conventional |
| | printer |
| | The final print out will be a sign that includes the barcode, user |
| | instructions on how to participate, and the service's brand features |
| [607] | The completed sign will be presented at the business venue |
| | The sign should be presented in a way that only customers can |
| | take advantage of submitting a scan (next to the cash register, for |
| | example) |
| [608] | Individual user (consumer) registers an account in order to |
| | participate in the service |
| [609] | Individual user creates and maintains a personal profile page |
| | with information such as age, gender, location, interests, |
| | occupation, contact details, etc. |
| [610] | Consumer installs mobile application on their compatible |
| | mobile phone |
| | Application requires link to a registered account |
| | Application enables user to: |
| | Check and update profile page |
| | Check reward- and status-points accounts |
| | Forward reward and reward point to other users |
| | Scan barcodes at participating venues to collect reward- and |
| | status-points |
| [611] | Mobile application extracts unique identifier from scanned |
| | barcodes |
| | Application sends unique identifier to server |
| [612] | Server receives request with unique identifier from mobile |
| | application |
| | Server identifies user |
| | Server validates unique identifier |
| | Upon successful validation, server retrieves corresponding data- |
| | set |
| [613] | Record of successful ‘check-in’ at participating venue is |
| | registered with the service |
| [614] | Information about the successful registration is sent to the |
| | profiles of the applicable venue & consumer user |
| | Includes the information about the participants of the |
| | transaction (venue & consumer) & date and time of |
| | transaction |
| [615] | The profiles of consumer users who ‘check-in’ at a given venue |
| | are automatically connected to the profile of that venue |
| | This connection enables each side to communicate with and |
| | keep track of the other |
| | Information about the transaction is published on the venue's |
| | profile page |
| | Users who are connected with the venue's profile can comment |
| | on recent activities |
| [616] | Successful ‘check-ins’ are published on the profile of the |
| | consumer user |
| | Published information contains link to venue's profile site, time, |
| | and date of transaction |
| | Users who are connected with the user's profile page can |
| | comment on recent activities |
| [617] | Consumer users earn reward-points and status-points for each |
| | successfully submitted check-in |
| | Reward points are associated with the issuing venue |
| | For each participating venue that a given consumer registers |
| | their ‘check-ins’ with, they will have a reward-points |
| | account that corresponds to that particular venue |
| | The requirements towards the number of reward-points that |
| | have to be accumulated in order to qualify for a given reward |
| | are specified by the participating business in the process of |
| | customizing the barcodes ([603]) |
| | Status points are collected accumulatively over time and are |
| | not intended to be redeemed for rewards |
| | Status points are merely intended to visualize a user's level |
| | of overall activity to the peers in their networks |
| | Virtual rewards and incentives are envisioned in regards to |
| | reaching certain levels of status-points - this will provide an |
| | additional social and emotional incentive for consumer users |
| | to participate frequently in the service |
| [618] | Consumer users connect with other users (similarly to other |
| | social networks) |
| | Users can exchange messages including text, pictures, video |
| | and links |
| | View updates and comments by connected users and their |
| | respective networks |
| [619] | Once a given reward-point threshold (specified by business |
| | user) has been reached, the consumer user receives a visual |
| | (digital) token that confirms their eligibility to redeem |
| | the reward |
| | All tokens that a consumer has acquired are stored in a |
| | dedicated section of the consumer user's profile |
| | Information about the user reaching eligibility and receiving the |
| | token is also sent to the applicable business user's profile |
| [620] | Consumer users can exchange tokens with peers in their |
| | network |
| | If a consumer user chooses to give a token to one of their peers, |
| | the token is placed in the applicable consumer user's dedicated |
| | profile section |
| | Along with the token, consumer users can send the applicable |
| | peer a message (similar to a gift card) |
| | When a token is forwarded, the receiving party and the |
| | applicable business user receive a message informing them |
| | about the transaction |
| | The applicable business user's profile is automatically |
| | connected to the receiving party's profile |
| [621] | Consumer users who are in possession of a business venue's |
| | reward tokens, can use these tokens to redeem applicable rewards |
| | Using the mobile application, consumer users navigate to the |
| | section of their profile in which the visual tokens are stored |
| | The consumer user selects the applicable token and presents it |
| | to the staff of the corresponding venue |
| | Upon inspecting and verifying the token, the venue's staff will |
| | ask the consumer user to mark the token as redeemed |
| | (“deactivate”) |
| [622] | When a consumer user marks a token as redeemed |
| | (“deactivate”) the visual appearance of the token changes in an |
| | easily identifiable way so that staff at the applicable venue can |
| | confirm the deactivation |
| | Upon confirming the deactivation, the venue's staff give the |
| | applicable reward to the consumer user |
| | When a token is marked as redeemed, a message is sent to the |
| | applicable business venue's profile, and a corresponding message |
| | is published on the consumer user's profile |
| [623] | A transaction is completed when a consumer user has |
| | deactivated a given token and received the applicable reward |
| | Information about the total number of completed transactions |
| | will be trackable for business users over time |

The inventive methods and systems for managing customer relationships are not restricted to the details provided with respect to the exemplary embodiments described above.

1. A method for managing customer relationships on a social networking site, the method comprising:
registering a first user of the social networking site comprising creating, by the first user, at least one business profile associated with a business and providing, by the first user, financial data for accounting purposes;
creating, by a second user of the social networking site, at least one individual profile associated with a potential customer;
generating, by the first or a third user of the social networking site, at least one machine readable token associated with at least one loyalty program of the business associated with the business profile;
displaying at a point of sale or service the at least one machine readable token in an intended business context;
capturing, by the second user, the at least one displayed machine readable token with a mobile device;
submitting, by the second user, information regarding the captured machine readable token to the social networking site;
creating a link on the social networking site between the business profile and the individual profile in response to the submitted information;
entering the second user into the loyalty scheme associated with the submitted information regarding the captured machine readable token and business profile, when the second user submits information regarding the captured machine readable token for the first time; and
awarding loyalty points to the second user in accordance with a reward policy of the loyalty program in response to the submission of the information regarding the captured machine readable token.

2. The method according to claim 1, wherein:
loyalty schemes of multiple businesses are hosted on the social networking site, such that the second user can participate in multiple loyalty schemes using a single registration of the individual profile in the social networking site.

3. The method according to claim 1, wherein:
the second user will lose all awarded reward points, if the second user deletes the link between the business profile and the individual profile to opt-out of the loyalty scheme.

4. The method according to claim 1, wherein the business profile is associated with the first user indirectly by means of one or more campaigns organized by a campaign manager.

5. The method according to claim 1, wherein the step of capturing the at least one machine readable token comprises obtaining a digital image of at least one barcode using an application of the mobile device and the step of submitting information comprises establishing a connection between the mobile application and a submission interface and submitting information regarding the captured machine readable token to the submission interface.

6. The method according to claim 5, further comprising identifying at least one identifier associated with the barcode using the application of the mobile device, and, in the step of submitting, transmitting the at least one identifier associated with the barcode to the submission interface.

7. The method according to claim 1, wherein:
the step of capturing the at least one machine readable token comprises obtaining a digital image of at least one machine readable token using a built-in camera of the mobile device; and
the step of submitting information comprises submitting the obtained digital image to the social networking site and identifying the machine readable token and associating it with the business profile by the social networking site.

8. The method according to claim 5, wherein the step of submitting information further comprises submitting at least one identifier associated with the second user, such as a user name, a universal device ID or a telephone number of the mobile device associated with the second user; to the social networking site.

9. The method according to claim 1, further comprising:
verifying the uniqueness of the submitted information based on auxiliary information associated with the captured machine readable token, such as a timestamp of a digital image.

10. A method for operating an electronic customer relationship management system, comprising:
storing at least one business profile and financial data for accounting purposes associated with a business;
storing a plurality of individual profiles associated with a plurality of potential customers;
providing an electronic version of at least one machine readable token associated with a loyalty program of the business associated with the at least one business profile through the electronic customer relationship management system for printing by a first user;
receiving information regarding at least one captured machine readable token from a mobile device associated with a second user;
verifying that the received information are associated with the at least one machine readable token provided to the first user;
creating a link on a social networking site between the at least one business profile and one of the plurality of individual profiles, which is associated with the second user from whom the information was received;
entering the second user into the loyalty scheme associated with the submitted information regarding the captured machine readable token and business profile, when the second user submits information regarding the at least one captured machine readable token for the first time; and
awarding loyalty points to the second user in accordance with a reward policy of the loyalty program in response to the submission of the information regarding the at least one captured machine readable token.

11. The method according to claim 10, wherein the social networking site comprises at least one privacy policy regarding access to information comprised in the first and individual profiles, the at least one privacy policy comprising a first rule for allowing the first user of the social networking site to send collective messages to second users of the social networking site, whose associated individual profiles are linked to the business profile, and for preventing to send collective messages to second users of the social networking site, whose associated profiles are not linked to the business profile.

12. The method according to claim 11, wherein the at least one privacy policy comprises a second rule for allowing first users of the social networking site to retrieve protected profile information of second users, whose associated individual profiles are linked to the business profile, and for preventing to retrieve protected profile information of second users of the social networking site, whose associated profiles are not linked to the business profile.

13. The method according to claim 11, wherein the at least one privacy policy comprises a third rule for allowing first users of the social networking site to retrieve aggregated information for all or a subset of second users, whose associated individual profiles are linked to the business profile.

14. The method according to claim 11, wherein the at least one privacy policy comprises a fourth rule for allowing second users of the social networking site, whose associated individual profiles are linked to the business profile, to access restricted information provided by the first user of the social networking site and for denying second users of the social networking site, whose associated individual profiles are not linked to the business profile, to access restricted information provided by the first user.

15. An electronic customer relationship management system, comprising:
a social networking site comprising a plurality of business profiles associated with a plurality of businesses and a plurality of individual profiles associated with a plurality of potential customers;
a token generator for on-demand generation of machine readable tokens associated with a loyalty program of at least one business associated with at least one of the plurality of business profiles;
a token submission interface for receiving information regarding at least one captured machine readable token from a plurality of mobile devices;
a link generator for creating a link on the social networking site between the business profile associated with a previously created machine readable token and the individual profile associated with the potential customer from whom the information regarding the at least one captured machine readable token was received;
a loyal scheme unit for entering the potential customer into the loyalty scheme associated with a submitted machine readable token and business profile, when the potential customer submits information regarding the at least one captured machine readable token for the first time; and
a reward system for awarding loyalty points to the potential customer in accordance with a reward policy of the loyalty program in response to the submission of the information regarding the captured machine readable token.

16. The electronic customer relationship management system according to claim 15, further comprising:
a messaging subsystem for sending collective messages from a first user associated with one of the plurality of business profiles to second users, whose associated individual profiles are linked to the respective business profile.

17. The electronic customer relationship management system according to claim 15, further comprising:
an analysis subsystem for providing aggregated data to a first user associated with one of the plurality of business profiles based on a plurality of individual profiles, which are linked to the respective business profile.

18. The electronic customer relationship management system according to claim 15, further comprising:
a user management subsystem for providing privileges to users of the electronic customer relationship management system, wherein a first user associated with at least one of the plurality of business profiles is privileged to grant administrative rights, for example for creating machine readable tokens associated with the business profile, to third users of the electronic management system.

19. A mobile application for use in the electronic customer relationship management system according to claim 15 comprising program code, which, when executed on a processing device of a mobile device such as a smart phone, having a camera and a communication interface for accessing a data network, performs the following steps:
capturing, using the camera of the mobile device, at least one machine readable token;
establishing a connection with a social networking site by providing at least one identifier associated with a user of the mobile device over the communication interface; and
submitting, using the communication interface, information regarding the captured machine readable token to the social networking site.

20. A computer program product comprising program code which, when executed on a processing device of networked server-computer, performs all steps of the method for operating an electronic customer relationship management system in accordance with claim 10.
